(19) United States
(12) Patent Application Publication
(10) Pub. No.: US 2023/0392924 A1
(43) Pub. Date: Dec. 7, 2023

(54) CONDENSER UNIT FOR PROVIDING DIRECTED LIGHTING OF AN OBJECT TO BE MEASURED POSITIONED IN A MEASURED OBJECT POSITION, IMAGING DEVICE AND METHOD FOR RECORDING A SILHOUETTE CONTOUR OF AT LEAST ONE OBJECT TO BE MEASURED IN A MEASURING FIELD USING AN IMAGING DEVICE AND USE OF AN ATTENUATION ELEMENT

(71) Applicant: JENOPTIK Optical Systems GmbH, Jena (DE)

(72) Inventors: Andrei TCHERNOOK, Limbach-Oberfrohna (DE); Thomas GOTTSCHALL, Jena (DE); Frank RICHTER, Jena (DE); Ralf HAMBACH, Jena (DE); Andre DATHE, Jena (DE)

(73) Assignee: JENOPTIK Optical Systems GmbH, Jena (DE)

(21) Appl. No.: 18/034,219

(22) PCT Filed: Oct. 26, 2021
(86) PCT No.: PCT/EP2021/079681

§ 371 Date: Apr. 27, 2023

(30) Foreign Application Priority Data
Oct. 28, 2020 (DE) 10 2020 128 394.6

(51) Int. Cl. G02B 19/00; G01B 11/24

(52) U.S. Cl. CPC G02B 19/0047; G01B 11/2433

(57) ABSTRACT

A condenser unit for providing directed lighting of an object to be measured positioned in a measured object position, wherein the condenser unit comprises a light source for emitting a light beam and an optical element having a positive refractive power. The condenser unit further comprises at least one attenuation element arranged in a common optical axis with the light source and the optical element, which attenuation element comprises a location-dependent light intensity attenuation effect for the light beam incident on the attenuation element, more particularly wherein the light intensity attenuation effect declines from the optical axis towards an edge of the attenuation element.

This nonprovisional application is a National Stage of International Application No PCT/EP2021/079681, which was filed on Oct. 26, 2021, and which claims priority to German Patent Application No 10 2020 128 394.6, which was filed in Germany on Oct. 28, 2020, and which are both herein incorporated by reference.

### BACKGROUND OF THE INVENTION

### Field of the Invention

The present invention relates to a condenser unit for providing directed lighting of an object to be measured positioned in a measured object position, an imaging device, and a method for recording a silhouette contour of at least one object to be measured in a measuring field using an imaging device according to the main claims and a use of an attenuation element, which has a location-dependent light intensity attenuation effect for the light bundle incident through the attenuation element.

### Description of the Background Art

To be able to optically measure an object to be measured, especially lighting adapted to the measurement objective in the angle distribution, efficient lighting, i.e., lighting having a high luminance and homogeneous lighting of this object to be measured plays an important role. Condenser units are often used for optimum lighting of this object to be measured, but are constructed from multiple components and, especially for lighting for telecentric systems, require a long structural form in the light direction and a large adjustment and material expenditure. On the other hand, existing flat emitters offer a compact structural form, but do not achieve strongly directed lighting having small numeric aperture (NA) with at the same time high efficiency for detection systems having strongly restricted acceptance NA (typical systems have NA<0.1) as are required, for example, for precision measurements in the silhouette contour method. A projector having adjustable and uniform brightness is known from U.S. Pat. No. 6,283,599 B1. The long structural length required by inter alia the reflector and the lens combinations used and the large number of required optical elements are disadvantageous.

### SUMMARY OF THE INVENTION

Against this background, the approach presented here presents an improved condenser unit for providing directed lighting of an object to be measured positioned in a measured object position. An improved imaging device and an improved method for recording a silhouette contour of at least one object to be measured in a measuring field using an imaging device is also presented.

The approach presented here creates a condenser unit for providing directed lighting of an object to be measured positioned in a measured object position, wherein the condenser unit includes the following features: at least one light source for emitting a light bundle; an optical element having a positive refractive power; and at least one attenuation element arranged in a common optical axis with the light source and the optical element, which has a location-dependent light intensity attenuation effect for the light bundle incident through the attenuation element, in particular wherein the light intensity attenuation effect decreases from the optical axis toward an edge of the attenuation element.

An optical element can be understood as an element which is designed to change a direction of a light beam incident through the optical element after an exit of the light bundle from the optical element. For example, a lens, a prism, or the like can be understood as an optical element. An attenuation element can be understood as an element by which an intensity of a light bundle incident through the attenuation element is reduced. The attenuation element thus acts as a damping element. The attenuation element is especially designed here so that the intensity of a light bundle is reduced at a first position, at which the light bundle passes the attenuation element, to a different extent than the intensity of the light bundle which passes the attenuation element at a second position. The attenuation element is in so far designed to also differently decrease an intensity of light beams which are incident on the attenuation element at different points. The damping effect is in this case especially made less in an edge area of the attenuation element than, for example, in an area arranged closer to the center of the attenuation element, which can lie on the optical axis. An intensity of a light beam which is incident on the attenuation element in the edge area is thus reduced less than an intensity of a light beam which passes the attenuation element in a middle area.

The approach presented here is based on the finding that a location-dependent damping effect of the light bundle by different areas of the optical element can be compensated for by the use of the attenuation element. This is particularly advantage especially if, for example, an intensity loss of the light bundle is different due to the natural vignetting by passing an optical element at different positions of this optical element. A high efficiency and a small installation space require a high numeric aperture NA_{Lightsource} of a light source, wherein the irradiance of the aperture of the lens decreases strongly toward the edge due to the natural vignetting, so that an intensity of a collimated light bundle would not be homogeneous in individual areas and thus could not be used for homogeneous lighting of the object to be measured positioned in the measured object position. Due to the use of the attenuation element now proposed, in contrast, in a very technically simple manner, an intensity of the light bundle may be reduced more strongly in those areas which were reduced less strongly upon passing the optical element. In this way, a condenser unit may very advantageously be implemented which, in addition to a good homogeneous illumination property for lighting an object to be measured, also has a high efficiency (in contrast to existing implementations of flat lights) and only places minor demands on required installation space.

According to one advantageous embodiment of the approach proposed here, the attenuation element can be made plate-shaped and/or the attenuation element can be arranged on a side of the optical element facing toward or facing away from the light source. Due to the use of a plate-shaped attenuation element, technically simple and inexpensive optical components can be used to implement such an attenuation element. The arrangement of the attenuation element on a side facing toward the light source offers the advantage that a spatially small element can be used as the attenuation element. On the other hand, the arrangement of the attenuation element on a side facing away from the light source offers the advantage of being able to provide or set a very homogeneous light intensity over the light bundle by fine tuning of the transparency of different areas on the attenuation element. The attenuation element can also be designed as a coating on a surface of the optical element, for example as a location-dependent absorption layer.

According to a further embodiment of the approach proposed here, a second attenuation element arranged in the optical path can be provided, which has a location-dependent light intensity attenuation effect for the light bundle incident through the second attenuation element. In particular, the second attenuation element can be made plate-shaped and/or a light intensity attenuation effect can decrease from the optical axis toward an edge of the second attenuation element and/or the attenuation element can be arranged in the optical path between the light source and the optical element and the optical element can be arranged between the light source and the second attenuation element. Such an embodiment of the approach proposed here offers the advantage of achieving a very precise and finally adjustable homogeneity distribution of the light bundle output by the condenser unit due to the use of two attenuation elements.

An embodiment of the approach proposed here is particularly advantageous in which the optical element is formed as a Fresnel lens. Such an embodiment offers the advantage of being able to achieve the implementation of a condenser unit which is short along the optical axis due to a very homogeneous light distribution and a low divergence of the light bundle originating from the condenser unit.

Furthermore, an embodiment of the approach proposed here is conceivable in which the attenuation element is arranged on a light entry surface or a light exit surface of the optical element. For example, the attenuation element can be vapor deposited or laminated onto a surface of the optical element. Such an embodiment of the approach proposed here offers the advantage, in addition to dispensing with a required alignment, of being able to produce a very installation space-saving condenser unit, since a distance between the optical element and the attenuation element can be minimized or dispensed with completely.

An embodiment of the approach proposed here is particularly advantageous in which a ratio of a structural height of the optical element and an aperture opening of the optical element is less than 1, in particular is less than 0.5. A structural height can be understood in the present case as a (for example three-dimensional) height of the condenser unit. For example, a diameter of the optical element or the attenuation element can be used or taken into consideration in the present case as an aperture opening. Such an embodiment of the presented approach offers the advantage of implementing a condenser unit with the smallest or shortest structural height possible. An optimum aspect ratio can thus be achieved if a maximization of homogeneity and efficiency in given limits is sought. In this way, a silhouette of this object to be measured can be detected precisely and easily very efficiently thereafter, when the object to be measured is lighted using a condenser unit designed in this way.

An embodiment of the approach presented here is particularly advantageous in which at least the attenuation element is designed as a gradient filter, an absorbing and/or reflecting binary filter, a scattering filter having periodic or randomly-distributed scattering elements, a diffractive or holographic optical element, and/or as a partial reflector. Such an embodiment offers the advantage of being able to use a technically mature, precisely working, and usually inexpensive and widely available element for the attenuation element in order to be able to produce an inexpensive condenser unit in this way. The attenuation element can especially also be implemented in one embodiment as an electronic component, in which the position-dependent light intensity attenuation effect can be set by individual control of the absorption and/or reflection properties of individual segments or pixels. Such an attenuation element can advantageously be embodied as a liquid crystal transmission display.

According to a further embodiment of the approach proposed here, the light source can also be designed as an LED light source, a fiber, scattering, or converting light source, for example as a light mixing rod, and/or having multiple sources, and/or the light source can have an extension which is less than one-fifth of the focal width f of the optical element. An advantageous embodiment is especially achieved by a condenser unit in which an adaptation of the extension of the light source to the NA of the measurement objective takes place. For example, a value of 0.2*f can be used for a divergence NAᵢₗₗ<0.1, wherein possibly a light source can also be used in which a somewhat greater value is used. Such an embodiment offers the advantage of high efficiency and the formation of a good contrast in the silhouette contour.

To be able to optically measure an object to be measured positioned in the measurement position particularly well, according to a further embodiment of the approach presented here, light incident on an object to be measured positioned in the measurement position can also be influenced in its angle distribution, which is emitted by the condenser unit. This can take place, for example, in that an adaptation of the angle distribution to the numeric aperture NA of the measurement objective takes place, wherein, for example, a typical restriction to NAᵢₗₗ<NA_{obj} can be provided; however, an expansion of the numeric aperture is also conceivable. Alternatively or additionally, a special angle distribution of the light beams of the light bundle can also be generated (in particular in combination with the shape of the light source, for example as a ring for dark field). To implement such a function, according to one embodiment of the approach presented here, a diffuser, a diffractive element, and/or an interference filter can be provided in the optical path to delimit an aperture of the condenser unit and/or the optical element.

Furthermore, an embodiment of the approach proposed here as an imaging device for optically measuring the object to be measured that can be positioned and/or is positioned at the measured object position in a measuring field is advantageous, wherein the imaging device includes the following features:

a condenser unit according to a variant of the approach presented here for lighting the object to be measured; an imaging objective; and an image sensor, wherein the imaging objective is designed to image the object to be measured on the image sensor and at least the attenuation element is designed to homogeneously light the image field associated with the field of view on the image sensor.

The image can advantageously be a transmitted light image. The image can also advantageously be a silhouette contour.

The advantages of the approach presented here may be implemented particularly efficiently and cost-effectively by such an embodiment. Furthermore, the light intensity attenuation effect of the attenuation element can be designed in such a way that vignetting by the imaging objective is also taken into consideration. In this way, a further improvement of the homogeneity of the illumination of the image sensor may be achieved.

Furthermore, according to a further embodiment of the approach presented here, a method for recording a silhouette contour of at least one object to be measured in a measuring field using an imaging device according to a variant of the approach described here is also presented, wherein the method includes the following steps:
generating a lighting light bundle using the condenser unit and lighting the object to be measured using the lighting light bundle;
imaging the silhouette of the object to be measured on an image sensor by means of an imaging objective, and recording the silhouette contour of the object to be measured using the image sensor.

The advantages of the approach presented here may also be implemented efficiently and inexpensively by such an embodiment.

The silhouette contour of the object to be measured in the measuring field can be recorded particularly precisely if, according to one embodiment of the approach proposed here, in the step of imaging, the silhouette of the object to be measured is imaged on the image sensor telecentric on the object side and/or telecentric on the image side.

According to one particularly advantageous embodiment, a use of an attenuation element is also presented, which has a location-dependent light intensity attenuation effect for the light bundle incident through the attenuation element in order to homogenize the illumination of an image field on an image sensor of an imaging device. This imaging device can comprise: a condenser unit for providing collimated lighting of an object to be measured positioned at a measured object position in a field of view associated with the image field; an imaging optical unit; and the image sensor arranged in an image plane of the imaging optical unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Particularly advantageous exemplary embodiments are described hereinafter on the basis of the appended drawings. In the figures:

FIG. 1 shows a schematic illustration of an exemplary embodiment of an imaging device;

FIG. 2 shows a diagram of an exemplary intensity curve of the irradiance in the aperture plane of the optical element or in the plane of the object to be measured;

FIG. 3 shows a schematic illustration of a further exemplary embodiment of an imaging device;

FIG. 4 shows a schematic illustration of a further exemplary embodiment of an imaging device;

FIG. 5 shows a schematic cross-sectional illustration through an exemplary arrangement of a light source having an optical element arranged downstream in the optical path to explain the functionality of the attenuation element;

FIG. 6 shows an exemplary diagram to illustrate an efficiency plotted on the y axis in relation to an aspect ratio plotted on the x axis;

FIG. 7 shows a schematic illustration of a further exemplary embodiment of an imaging device;

FIG. 8 shows a schematic illustration of a further exemplary embodiment of an imaging device;

FIG. 9 shows a schematic illustration of a further exemplary embodiment of an imaging device;

FIG. 10 shows a flow chart of an exemplary embodiment of a method for recording a silhouette contour of at least one object to be measured in a measuring field using a variant presented here of an imaging device.

### DETAILED DESCRIPTION

Identical and/or functionally identical elements are designated by identical and/or similar reference signs in the different figures, wherein a further extensive description of these elements is omitted for simplification and easier readability.

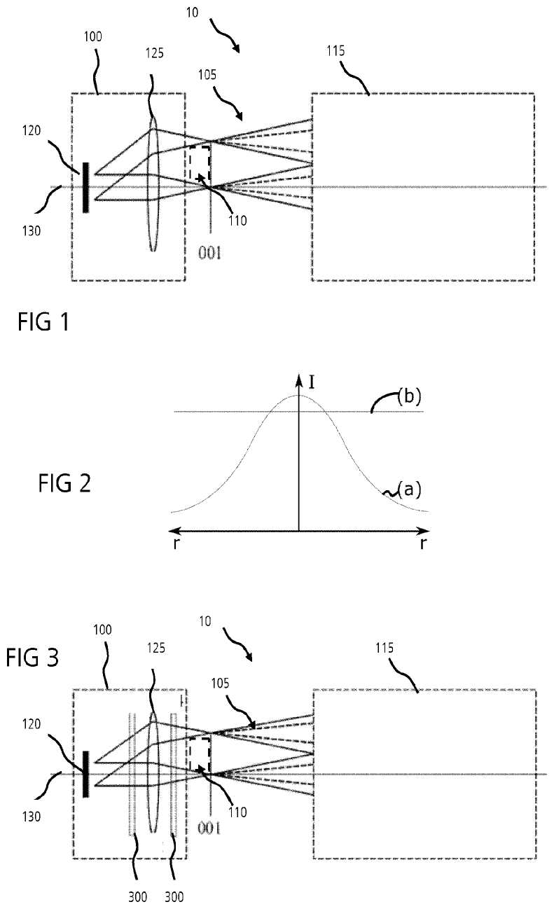

FIG. 1 shows a schematic illustration of an exemplary embodiment of an imaging device 10, as can be used as the fundamental arrangement for an exemplary embodiment of the approach presented here. The imaging device 10 comprises a condenser unit 100 for generating or providing a light bundle 105 having a small divergence. This is suitable in particular for lighting objects to be measured 110 in the object plane in a measurement position 001, which is to be measured with high accuracy by means of, for example, a telecentric detector unit 115 in the silhouette contour method. In this application, the smallest possible numeric aperture NA matched with the detection system 115 is advantageous. Such a condenser unit 100 consists here, for example, at least of a light source 120, such as an LED, laser diode, fiber, scattering, or converting light source, which is positioned, for example, in the focal point of an optical element 125. FIG. 1 thus shows an arrangement in which the condenser unit 100 outputs the light bundle 105 from a light source 120 on an optical element 125, such as a Fresnel lens, at which the light bundle 105 is collimated. The light source 120 consists here, for example, of a single emitting element. The size or width of the emitter or the light source 120 is selected, for example, in such a way that the numeric aperture NA of the final light bundle 105 is less than 0.1 upon the exit from the condenser unit 100. The light source 120 and the optical element 125 are arranged or aligned on a common optical axis 130.

An aperture or opening D can be understood as the largest extension of the beam path in an aperture plane perpendicular to the optical axis. The aperture plane can be the light exit-side main plane of the optical element. The structural height can be understood as the distance of the light source to the light exit-side surface (or its largest z coordinate if z is defined in the direction of the optical axis) of the optical element or the light exit surface of the attenuation element along the optical axis, depending on which measure is larger.

To achieve the most compact possible construction of the condenser unit 100 and thus also the imaging device 10, the optical element 125 is selected in such a way that its focal length is as small as possible in relation to its aperture. The smaller this ratio is selected to be, the more strongly the beam density of the collimated light bundle 105 drops toward the edges. This results because a natural vignetting=reduction of the irradiance of the aperture of the lens takes place with increasing distance to the optical axis (due to projection of the angle and increasing distance to the light source).

FIG. 2 shows a diagram of an exemplary intensity curve I of the irradiance plotted on the y axis in the aperture plane of the optical element, or in the (measuring) plane 001 of the object to be measured 110. The curve provided with the reference sign (a) of the profile of the light intensity I over the radial distance r from the optical axis 130 shows this high damping behavior in the edge areas having large distance r from the optical axis. The curve (a) thus shows an inhomogeneous distribution of the radiation density, which has negative effects on the measurement accuracy of the measurement of the object to be measured 110.

In contrast, an approximately constant level of the light intensity of the light bundle 105 would be desirable to achieve the most precise and detailed possible optical evaluation of the object to be measured 110 at the measuring position 001 by the detector unit 115, as shown in the curve having the reference sign (b) in FIG. 2. Such a curve (b) can be obtained according to the approach presented here by using a suitable attenuation element.

FIG. 3 shows a schematic illustration of a further exemplary embodiment of an imaging device 10, which includes an arrangement of the optical components in accordance with the illustration from FIG. 1, supplemented with an attenuation element 300 arranged in the optical path 130 in the condenser unit 100. The gradient of the beam density described with reference to FIG. 2 according to the curve (a) is thus corrected by an attenuation element 300 having location-dependent (light intensity) attenuation effect at a position between the light source 120 and the optical element 125 and/or at a position on a side of the optical element 125 facing away from the light source 120. In this way, the beam density or intensity of the light bundle 105 output by the condenser unit 100 can be corrected over the entire aperture of the condenser unit 100 to a predetermined intensity distribution, as shown in FIG. 2 according to the curve (b).

The attenuation element 300 at the position between the light source 120 and the optical element 125 and/or on the side of the optical element 125 opposite to the light source 120 can be implemented, for example, by a gradient filter (gray filter), binary filter (absorbing or reflecting), scattering filter having periodic or randomly-distributed scattering elements (diffractive or holographic optical elements), or a partial reflector (polarization-dependent, polarization-independent, or chromatic). It is furthermore also conceivable that the attenuation element 300 is vapor deposited or laminated as a layer on the optical element, and a very compact condenser unit 100 may be implemented in this way.

In the configuration or arrangement of the attenuation element 300 on the side of the optical element 125 facing away from the light source 100, as shown in FIG. 3, the light bundle 105 which originates from the light source 120 passes through the optical element 125 first and then the attenuation element 300. In this case, the size/width of the attenuation element 300 at the position following the optical element 125 approximately corresponds to that of the optical element 125. The precise distance of both elements, thus of the attenuation element 300 and optical element 125, can be selected freely.

In a second configuration, the attenuation element 300 is located at a position between the light source 120 and the optical element 125, the light bundle 105 passes through it first and subsequently passes the optical element 125. In this case, the size of the attenuation element 300 at the position between the light source 120 and the optical element 125 is related to its three-dimensional location. For the most uniform possible beam density of the emitted light bundle 105 over the entire aperture, the distance is accordingly to be adjusted accurately. If a partial reflector is used as an attenuation element 300 in this configuration, the surface around the optical element 125 is supposed to absorb the reflected light. Specific spatial and angle-dependent emission characteristics of the light bundle 105 may be achieved by the integration of (for example also multiple) attenuation elements 300 at a position between the light source 120 and the optical element 125 and/or a position on a side of the optical element 125 facing away from the light source 120. No deflection mirrors or beam splitters are required in the beam path and it is made possible that a compact vertical structural form of the condenser unit 100 can thus be achieved, substantially determined by the focal length of the optical element 125.

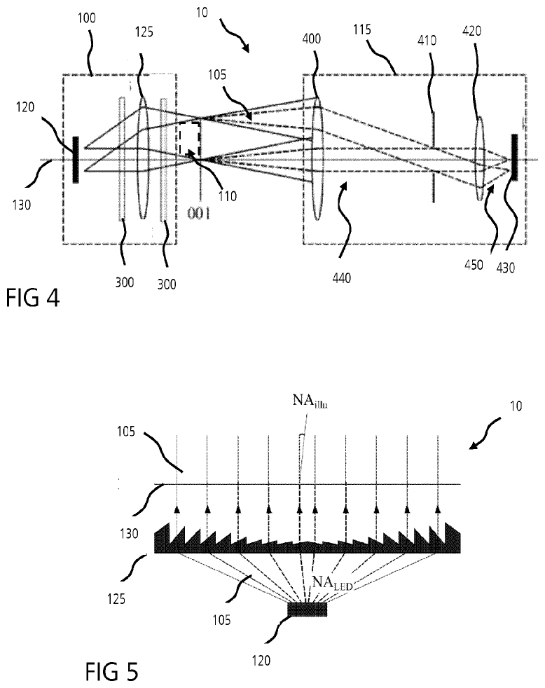

FIG. 4 shows a schematic illustration of a further exemplary embodiment of an imaging device 10, which includes an arrangement of the optical components according to the illustration from FIG. 3, supplemented by optical components of the detector unit 115 arranged in the optical path 130. The optical detection system or the detector unit 115 comprises as optical components an object-side optical element 400 (which comprises a lens, for example), a stop element 410 (for example an aperture), an image-side optical element 420 (for example also a lens again), and a surface sensor element or image sensor 430. The object-side optical element 400, the stop element 410, and/or the image-side optical element 420 can be combined as an imaging optical unit or imaging objective. The quality of the achieved lateral beam density of the light bundle 105 is defined here via the homogeneous illumination of a surface sensor element or an image sensor 430 in the optical detection unit 115 and its object-side numeric aperture.

This imaging device 10 can be used particularly advantageously in the silhouette contour method, wherein a silhouette of the object to be measured 110 results on the image sensor 430. To avoid the paradox of a homogeneously illuminated shadow, a field of view 440 and an image field 450 are defined. The field of view 440 designates in this case an object-side area, which can be imaged on the image sensor 430 by means of the imaging optical unit (according to the illustration from FIG. 4, for example, the object-side optical element 400, the stop element 410, and the image-side optical element 420). The image field 450 corresponds, for example, to the area illustrated in FIG. 4, which corresponds to an area visible due to the effect of the aperture 410 on the image sensor 430, an area visible through the aperture of the imaging optical unit, and/or a part of the image plane of the object-side field of view 440 delimited by the sensitive surface of the image sensor 430. The image field 450 can comprise, but does not have to, the entire sensitive surface of the image sensor 430. The homogeneity of the illumination of the image field 430 can advantageously be determined without the presence of an object to be measured 110.

To effect such a homogeneous illumination of the sensor 430, according to the approach presented here, the condenser unit 100 advantageously adapted to the imaging optical unit is used.

FIG. 5 shows a schematic cross-sectional illustration through an exemplary arrangement of a light source 120 having an optical element 125, which is designed here as a Fresnel lens, arranged downstream in the optical path 130. The light 105 emitted from the light source 120, which is designed as a single emitter having the numeric aperture NA_{LED}, passes through the optical element 125, such as a Fresnel lens. The radial gradient of the beam density or the intensity distribution of the light bundle 105, which would result after the optical element 125 according to the curve (a) from the diagram of FIG. 2, is now corrected via the attenuation element 300 to achieve a homogeneous illumination and equalized to an approximately constant level, so that the condenser unit 100 has a light bundle 105 having a very homogeneous light distribution at a numeric aperture NAᵢₗₗ. The emission angle of the light source 120, which increases with the distance to the optical axis, is also apparent in FIG. 5, as well as the increasing distance to the optical element 125, which causes a reduction of the irradiance in the plane of the optical element 125 (natural vignetting).

The overall efficiency r of the condenser unit 100 may be determined here in a simple model via the following relationships: The collection efficiency η₁ 600 describes the proportion of the light emitted by the light source 120 which irradiates the effective aperture of the optical element 125. For a Lambertian emitter, the following results

$${η}_{1} = {NA}_{LED}^{2} , \qquad {NA}_{LED} = sin ( arc tan ( \frac{D}{2 f} ) )$$

with the numeric aperture of the light source NA_{LED} according to the illustration from FIG. 5, the diameter of the aperture opening D, and the focal length f of the optical element 125. The irradiance E(r) in the object plane results due to the natural vignetting of the lens or the optical element 125 as:

$$E ( r ) = {{E}_{0} [ cos ( arc tan ( \frac{r}{f} ) ) ]}^{4}$$

An ideally assumed attenuation element 300 at a position between the light source 120 and the optical element 125 and/or at a position on a side of the optical element 125 opposite to the light source 120 reduces the irradiance according to the homogeneity requirement (here 50%) to E′(r):

$${E}^{′} ( r ) = \{ \begin{matrix}E ( r ) & E ( r ) < {E}_{c} \\ {E}_{e} & else\end{matrix} , {E}_{c} = 2 * E ( D / 2 )$$

The efficiency η₂ 610 results from the ratio of the optical radiation flux with attenuation element φ′ and without attenuation element φ as

η₂=Φ′/Φ,Φ^{(′)}=2π∫₀^{D/2}drrE^{(′)}(r)

The overall efficiency η of the system is then the product of the individual efficiencies:

η=η₁η₂

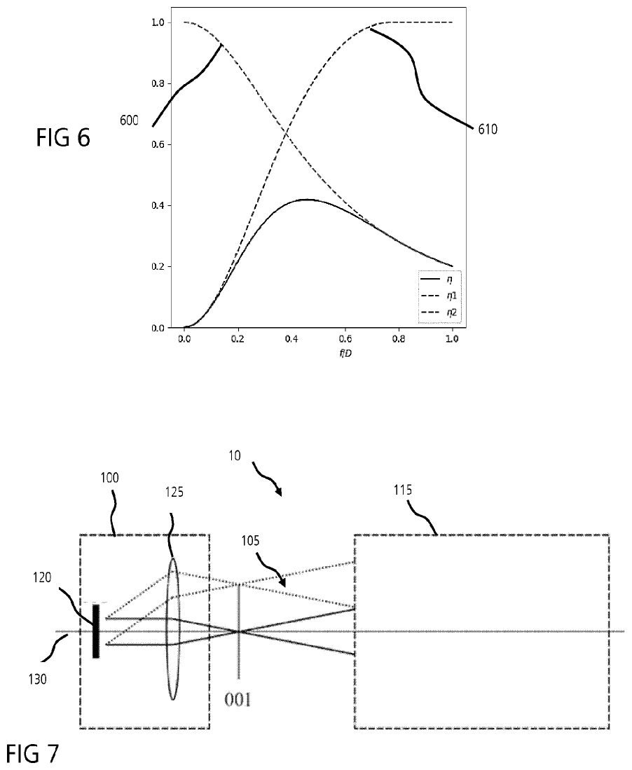

FIG. 6 shows a diagram in which the aspect ratio is plotted on the x axis and an efficiency is plotted on the y axis. A nominal overall efficiency η of the condenser unit 100 can be calculated as a function of the aspect ratio f/D from the individual efficiencies η₁ 600 and η₂ 610 for an assumed requirement of a local intensity homogeneity (E′ₘᵢₙ/E′ₘₐₓ) in the imaging system of 50%.

The concept presented here of a novel condenser unit 100 differs from other implementations of directed lighting with slight variation in the angle over the aperture (according to priority): due to the low aspect ratio (focal length of the optical element 125/diameter of the optical element 125) less than 1.

A high efficiency at low NAᵢₗₗ<0.1 in the outgoing beam bundle high homogeneity

In the condenser unit 100 presented here, in addition to the good setting of a homogeneous light distribution, furthermore a simple construction and a minor or absent alignment effort is particularly advantageous. A condenser unit 100 can be provided here which has a small numeric aperture (NAᵢₗₗ<0.1, which corresponds to a divergence angle±5.7°), a large diameter D of the illuminated surface (measuring field in the area of the object to be measured 110) with small structural height b of the condenser unit 100 and large lighting surface at the same time.

The approach presented here can be used for multiple different applications, for example for an adapted illumination for telecentric measuring objectives or for compact measuring microscopes having small aperture.

In the following description, particularly advantageous exemplary embodiments of the condenser unit 100 are explained once again, wherein the arrangement of the attenuation element 300 was omitted for reasons of clarity; however, it is to be noted here that the attenuation element 300 can be arranged both between the light source 120 and the optical element 125 and in the beam path after the optical element 125, as already described above.

FIG. 7 shows a schematic illustration of an exemplary embodiment of an imaging device 10, in which telecentric lighting parallel to the optical axis or the optical path 130 is provided (by aligning the light source 120 in the focal plane of the focusing lens as the optical element 125 orthogonally and symmetrically to the optical axis 130).

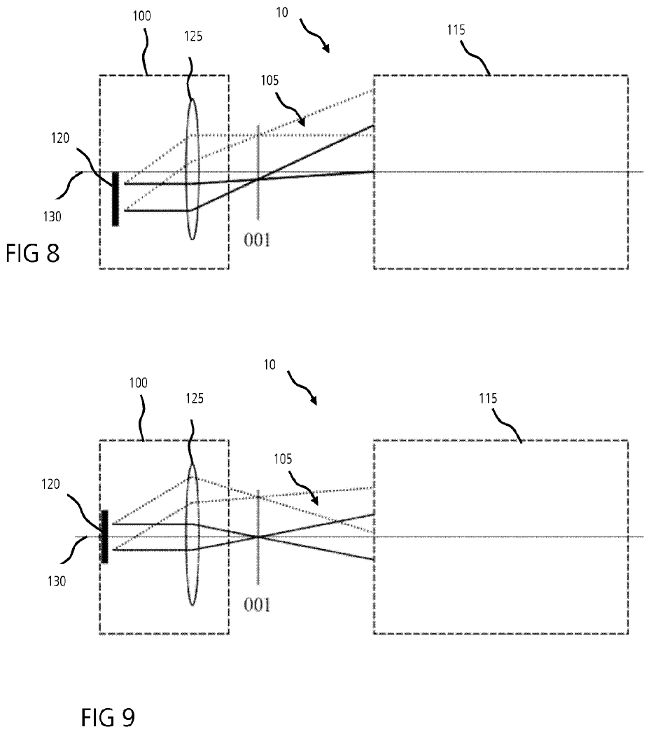

FIG. 8 shows a schematic illustration of an exemplary embodiment of an imaging device 10, in which telecentric lighting not parallel (i.e., oblique) to the optical axis 130 is carried out (for example by orthogonal displacement of the light source 120 or the emitter or the focusing lens as optical element 125 to the optical axis 130).

FIG. 9 shows a schematic illustration of an exemplary embodiment of an imaging device 10, in which non-telecentric lighting is provided (for example by axial defocusing of the light source 120 or the emitter or the focusing lens as optical element 125). This enables the adaptation of the condenser unit 100 to non-telecentric imaging objectives 115 as well.

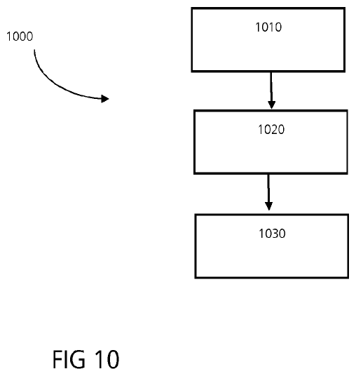

FIG. 10 shows a flow chart of an exemplary embodiment of a method 1000 for recording a silhouette contour of at least one object to be measured in a measuring field using an imaging device according to a variant presented here, wherein the method 1000 includes a step 1010 of generating lighting light using the condenser unit 100 and lighting the object to be measured using the lighting light. Furthermore, the method 1000 comprises a step 1020 of imaging the silhouette of the object to be measured on an image sensor by means of an imaging device. Finally, the method 1000 comprises a step 1030 of recording the silhouette contour of the object to be measured using the image sensor.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A condenser unit for providing directed lighting of an object to be measured positioned in a measured object position, wherein the condenser unit includes the following features:
at least one light source for emitting a light bundle;
an optical element having a positive refractive force; and
at least one attenuation element arranged in a common optical axis with the light source and the optical element, which has a location-dependent light intensity attenuation effect for the light bundle incident through the attenuation element (300), in particular wherein the light intensity attenuation effect decreases from the optical axis to an edge of the attenuation element.

2. The condenser unit as claimed in claim 1, characterized in that the attenuation element is made plate-shaped and/or the attenuation element is arranged on a side of the optical element facing toward or facing away from the light source.

3. The condenser unit as claimed in claim 1, wherein a second attenuation element arranged in the optical axis, which has a location-dependent light intensity attenuation effect for the light bundle incident through the second attenuation element, in particular wherein the second attenuation element is made plate-shaped and/or a light intensity attenuation effect of the second attenuation element decreases from the optical axis toward an edge of the second attenuation element and/or the attenuation element is arranged in the optical axis between the light source and the optical element and the optical element is arranged between the light source and the second attenuation element.

4. The condenser unit as claimed in claim 1, wherein the optical element is formed as a Fresnel lens.

5. The condenser unit as claimed in claim 1, wherein the attenuation element is arranged on a light entry surface or a light exit surface of the optical element.

6. The condenser unit as claimed in claim 1, wherein a ratio of a structural height of the optical element and an aperture opening of the optical element is less than 1, in particular less than 0.5.

7. The condenser unit as claimed in claim 1, wherein at least the attenuation element is designed as a gradient filter, an absorbing and/or reflecting binary filter, a scattering filter having periodic or randomly-distributed scattering elements, a diffractive or holographic optical element, and/or as a partial reflector.

8. The condenser unit as claimed in claim 1, wherein the light source is designed as at least one LED light source, a fiber, scattering, or converting light source, and/or in that the light source has an extension which is less than one-fifth of the focal length f of the optical element.

9. The condenser unit as claimed in claim 1, wherein a diffuser, a diffractive element, and/or an interference filter is provided in the optical axis to delimit an aperture of the condenser unit and/or the optical element.

10. An imaging device for optically measuring the object to be measured, which can be positioned and/or is positioned in the measured object position in a field of view, wherein the imaging device includes the following features:
a condenser unit as claimed in claim 1 for lighting the object to be measured;
an imaging optical unit; and
an image sensor, wherein the imaging optical unit is designed to image the object to be measured on the image sensor and at least the attenuation element is designed to homogeneously light the image field assigned to the field of view on the image sensor.

11. A method for recording a silhouette contour of at least one object to be measured in a measuring position using an imaging device as claimed in claim 10, wherein the method includes the following steps:
generating a lighting light bundle using the condenser unit and lighting the object to be measured using the lighting light bundle;
imaging the silhouette of the object to be measured on an image sensor by means of an imaging optical unit, and
recording the silhouette contour of the object to be measured using the image sensor.

12. The method as claimed in claim 11, characterized in that in the step of imaging, a silhouette of the object to be measured is imaged on the image sensor telecentric on the object side and/or telecentric on the image side.

13. A use of an attenuation element, which has a location-dependent light intensity attenuation effect for the light bundle incident through the attenuation element, for homogenizing the illumination of an image field on an image sensor of an imaging device, wherein the imaging device comprises:
a condenser unit for providing collimated lighting of an object to be measured positioned in a measured object position in a field of view associated with the image field;
an imaging optical unit; and
the image sensor arranged in an image plane of the imaging optical unit.
